(19) United States
(12) Patent Application Publication
(10) Pub. No.: US 2010/0255943 A1
(43) Pub. Date: Oct. 7, 2010

(54) POLYMER SPRING CONTROLLED PULLEY ASSEMBLY FOR ROTARY DEVICES

(76) Inventors: Connard Cali, Pleasanton, CA (US); Frank A. Fitz, Poway, CA (US); Carlos Ferreira, Brusque-Santa Catarina (BR)

Correspondence Address: LAW OFFICES OF BARRY N. YOUNG, 200 PAGE MILL ROAD, SUITE 102, PALO ALTO, CA, 94306, US

(21) Appl. No.: 12/420,035

(22) Filed: Apr. 7, 2009

(51) Int. Cl. F16H 55/48

(52) U.S. Cl. 474/94

(57) ABSTRACT

A drive system for a rotary device, such as an automotive alternator compensates for and reduces the effect of sudden bidirectional rotational velocity variations of the pulley caused by sudden acceleration and deceleration of an internal combustion engine without using a one-way clutch. The drive system comprises a pulley comprising a tubular barrel having a plurality of radial projections extending inwardly from its inner surface, and a cylindrical hub that is journaled within the pulley and connected to the alternator shaft. The hub has a plurality of radial projections extending outwardly from its outer circumference which are interleaved between the pulley projections. A plurality of solid resilient polymer spring members are disposed in the cavity spaces between the projections. Upon sudden acceleration or deceleration of the pulley, it rotates angularly relative to the hub and shaft to resiliently compress the polymer spring members, which exert a counter restoring force to eliminate the relative angular rotation.

### BACKGROUND

This invention relates generally to drive systems for rotary devices, and more particularly to pulley assemblies for rotary automotive accessory devices such as alternators.

Some systems which employ rotary prime movers as drivers for providing rotational motive power for driving rotary accessory devices are characterized by dynamic loading and inertial torque characteristics which result in rotational perturbations that are transmitted to the accessory devices. An example of such systems is an internal combustion engine that drives rotary accessory devices such as an alternator, air-conditioning compressor, water pump, etc. Rotation of the engine crankshaft is transmitted via a serpentine or poly-V belt system or conventional V-belt systems to pulleys attached to the drive shafts of such accessory devices to rotate their shafts. In some cases the mechanical connection between crankshaft and the accessory device is a gear train. The rotation of an internal combustion engine crankshaft is, however, subject to perturbations, the magnitude and frequency of which varies with engine RPM. During combustion, the crankshaft temporarily speeds up and generates a pulse of rotational power that is transmitted via the belt to the rotary accessories. During compression, the crankshaft temporarily slows down. Thus, the crankshaft continually exhibits acceleration and deceleration and effectively imparts a pulsed driving characteristic to the drive system, which in turn is transmitted to the accessory devices. Generally, the slower the rotational speed of the crankshaft or the fewer the number of cylinders, the greater the pulse effect. At engine idle, for instance, the magnitude of the variations is the greatest and the effects most noticeable.

In the case of a belt driven device, crankshaft pulsations are transmitted to the drive belt system and the driving pulleys of accessory devices as dynamic rotational velocity fluctuations. The inertias of the rotary devices tend to resist the velocity fluctuations, which generates dynamic tensions in the belt as it tries to accelerate and decelerate the rotary devices to accommodate the fluctuations. Conventional belt tensioners react to these dynamic fluctuations but cannot compensate for them. The fluctuations are transmitted to the shafts of the rotary devices through their pulleys, and may produce undesirable belt slippage, noise and vibration that are transmitted to a passenger compartment, as well as cause wear and tear on the rotary devices. This results in higher than desirable belt wear and shortens the life of the rotary devices. Automotive alternators are particularly susceptible to increased wear and decreased life due to such fluctuations because of their high inertia and high speed, and they tend to fail frequently.

One approach which has been proposed to address the problem of dynamic fluctuations and reduced life of rotary devices, such as automotive alternators, has been to employ one-way clutches in the pulleys of the rotary devices. Conventional one-way clutches are mechanical devices that engage when the alternator pulley rotates in the driving direction but disengage when the pulley rotates in the opposite direction relative to the shaft so that the shaft may overrun. One-way clutches accommodate crankshaft slowdown reasonably well since they disengage the pulley from the shaft and overrunning permits the shaft to continue rotating under the inertia of the alternator shaft and armature. However, one-way clutches do not satisfactorily accommodate abrupt increases in speed, as when combustion occurs, since they engage suddenly and attempt to accelerate the shaft rotation rapidly to match the increased belt velocity. Sudden engagement of the one-way clutch with the pulley results in noise, high wear and frequent failure of the one-way clutch, and may shorten the life of the alternator bearings, as well as the drive belt. One-way clutches used in high frequency loading environments have high failure rates, as do other components of drive systems employing one-way clutches. Moreover, one-way clutches do not eliminate the problems of rotational velocity fluctuation, noise and vibration since they address only belt deceleration but not belt acceleration.

Another approach that has been proposed is to implement an isolator for an alternator pulley with a one-way clutch implemented using coil springs that permit some relative resilient rotational movements in opposite directions with respect to the alternator pulley. When the pulley accelerates, a coil spring about the shaft tightens and engages the shaft rapidly, typically in about a degree or so of angular rotation, to abruptly impart rotation to the shaft. In the opposite over-running direction, the pulley is free to decelerate relative to the alternator shaft.

Known approaches using one-way clutches and isolators in drive systems that are subject to rapid and frequent rotational perturbations are reasonably effective for noise and vibration damping, i.e. attenuation, but are complex, expensive, and have high failure rates. There is a need for solutions that overcome these shortcomings.

There is further a need for an improved drive system for coupling a rotating driver to the shaft of a rotating device that compensates for sudden relative rotational angular velocity differences between the driver and the rotating device due to sudden acceleration and deceleration by allowing bidirectional relative rotations between the driver and the rotating device. More particularly, it is desirable to provide an improved driving system for a rotary device in a dynamically changing environment that is simpler, less expensive, more reliable, has a longer lifetime, and that affords better compensation of noise and vibrations than known approaches. It is desirable to address these and other problems of coupling rotary drivers and rotary devices, and it is to these ends that the present invention is directed.

### SUMMARY OF THE INVENTION

The invention affords drive systems for rotary devices that address the foregoing and other problems of coupling rotary drivers and rotary devices, including those that attempt to compensate for sudden rotational velocity changes. Drive systems in accordance with the invention compensate for accelerations and decelerations to substantially attenuate or eliminate the impact of abrupt velocity changes on the shaft of a rotary device. The drive systems operate bidirectionally and afford predetermined attenuations of the effects of sudden relative rotational changes in opposite rotational directions. They accommodate both relative accelerations and decelerations of a driver and a rotary shaft by allowing a drive pulley and the shaft to smoothly and softly engage and disengage over a predetermined range of angular rotations. This is accomplished while maintaining a direct resilient coupling between the pulley and the drive shaft that accommodates abrupt rotational velocity changes and that smoothly counteracts the changes to restore equilibrium, thereby affording greater control of the relative rotations of the pulley and the shaft. Significantly, the invention does not include a one-way clutch.

In accordance with one aspect, the invention provides a drive system for a rotary device having a driven shaft that is coupled to a pulley. A hub is connected to the shaft and journaled within the pulley to rotatably support the pulley. The hub and pulley are coupled by a plurality of solid resilient polymer spring members that are disposed between interleaved projections formed on facing surfaces of the pulley and the hub. The polymer spring members allow resilient relative bidirectional rotation of the pulley and hub over a predetermined range of angular rotations such that sudden bidirectional relative rotational velocity changes due to accelerations and decelerations of the pulley and the hub are cushioned by providing an increasing torque over said predetermined range to smoothly reduce the velocity differential and attenuate the impact of the velocity changes on the shaft.

In another aspect, the invention affords a drive system for a rotary device comprising a pulley and a hub journaled within the pulley and connected to a shaft of the rotary device. The pulley and hub are formed with first and second pluralities of interleaved radially extending projections that form a plurality of cavities therebetween. A plurality of solid polymer spring members are disposed within corresponding cavities, and are arranged to be deformed by the projections upon relative angular rotation of the pulley and the hub due to sudden rotational velocity changes. The drive system operates bidirectionally for both relative accelerations and decelerations of the pulley and the shaft. Deformation of the spring members reduces the impact of velocity changes while attenuating noise and vibrations by affording controlled resilient bidirectional relative angular rotation between the pulley and the hub. Upon being deformed, the spring members exert a restoring force on the projections to accommodate the relative angular rotation between the pulley and the shaft.

In still a further aspect, the invention affords a method of coupling a shaft of a rotary device and a pulley in which the pulley is coupled to the shaft by solid resilient polymer spring members located between symmetrically disposed interleaved projections formed on a hub connected to the shaft and the pulley. The resilient polymer may be selected to be polyether urethanes or polyester urethanes having a Shore A durometer hardness in the range of 60 to 90, or co-polyesters of fully polymerized hard segments of crystalline polybutylene-terephthalate (PBT) and soft segments of amorphous polyesters or polyethers. The spring members afford a resilient connection between the hub and pulley, and allow bidirectional angular rotation of the shaft and pulley over a predetermined range. Upon relative acceleration and deceleration between the pulley and the shaft, the springy connection allows the pulley and shaft to rotate angularly relative to one another to softly engage and disengage to control the effects of sudden rotational velocity changes.

### BRIEF DESCRIPTION OF THE DRAWINGS

FIG. 1 is a perspective view of a pulley assembly for a rotary device incorporating a drive system in accordance with the invention;

FIG. 2 is an exploded perspective view of the pulley assembly of FIG. 1 that illustrates the components of a first embodiment of the drive system of the invention;

FIG. 3 is an end view of the pulley assembly of FIG. 1;

FIG. 4 is a longitudinal cross sectional view of the pulley assembly taken approximately along the lines 4-4 of FIG. 3;

FIG. 5 is a transverse cross sectional view of the pulley assembly taken approximately along the lines 5-5 of FIG. 4;

FIG. 6 is a perspective view of an embodiment of a hub of the pulley assembly;

FIG. 7 is a perspective view of a pulley of the pulley assembly;

FIGS. 8A-8E are perspective views of alternative embodiments of spring members that may be employed in the pulley assembly of the invention;

FIG. 9 is a graph illustrating a linear relationship between torque and shaft displacement angle of a pulley assembly in accordance with an embodiment of the invention;

FIG. 10 is a graph illustrating a relationship between torque and shaft displacement for a loose spring embodiment of the invention; and

FIG. 11 is a graph illustrating a relationship between torque and shaft displacement for an asymmetrical spring embodiment of the invention.

### DESCRIPTION OF PREFERRED EMBODIMENTS

The invention is particularly well adapted for use in automotive applications and will be described in that context. It will be appreciated, however, that this is illustrative of only one utility of the invention, and that the invention has broader applicability to other applications. As will be appreciated from the description which follows, the invention advantageously reduces noise and vibration in applications and systems which employ rotating prime movers or drivers, such as internal combustion engines or the like, that are characterized by pulsed rotational variations or velocity perturbations, and rotary devices driven by the prime movers.

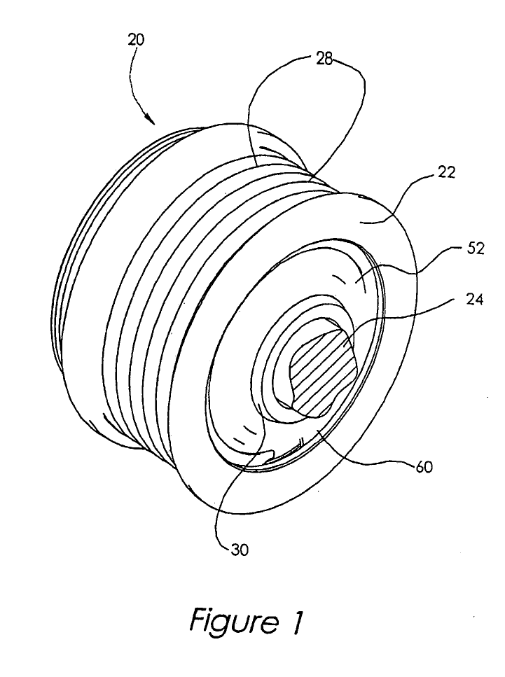

FIG. 1 shows a perspective view of a pulley assembly 20 comprising a pulley 22 and a drive system in accordance with the invention. The pulley assembly is adapted to be located on the end of a drive shaft 24 of a rotating device, such as an automotive alternator (not illustrated), and to be driven in a well known manner by a drive belt (not illustrated), such as a serpentine or poly-V belt, of an internal combustion engine to rotate the alternator shaft.

As will be described in more detail below, the invention affords relative bidirectional rotational movement or slippage between the pulley 22 and the shaft 24 to compensate for rotational perturbations between the engine and the rotary device. With internal combustion engines, the rotational perturbations are most pronounced at low RPMs, as at engine idle. At higher RPMs, the rotational velocity changes are smaller, and at normal operating speeds, e.g. above about 1200 RPMs, they may be substantially unnoticeable. In steady-state conditions when the crankshaft of the internal combustion engine is rotating at a substantially constant speed, the pulley and the alternator shaft will be rotating at substantially the same speed. When the engine crankshaft suddenly accelerates, as during a combustion stroke, there is a substantially instantaneous (typically within a fraction of a second) increase in its rotational velocity in a drive direction that is transmitted to the pulley through the drive belt, which attempts to impart the sudden velocity change to the alternator. However, the inertia of the alternator shaft and armature tend to resist abrupt rotational speed changes, causing a sudden impact and vibration and noise as the drive belt attempts to abruptly change the rotational velocity of the alternator shaft.

The invention permits the pulley to accelerate suddenly and rotate relative to the alternator shaft, i.e., slip, by a predetermined angular rotation, as will be described, while remaining resiliently coupled. Thus, the sudden acceleration of the pulley is not transmitted immediately to the shaft. Rather, the resilient coupling between the pulley and the shaft permits relative angular rotation or slippage between the pulley and shaft as the pulley suddenly accelerates. As the relative angular deviation between the pulley and the shaft increases, the coupling between the pulley and the shaft, which varies with angular deviation, also increases. This causes a smoothly increasing engagement between the pulley and shaft and a corresponding smoothly increasing acceleration of the shaft to match the rotational velocity of the pulley. Thus, the impact of sudden impulses to the pulley are reduced and cushioned so that abrupt speed changes are transmitted more gradually to the shaft over a range of angular rotations, thereby reducing or substantially eliminating abrupt force variations in the belt and corresponding vibration and noise.

When the rotational velocity of the pulley decreases, as during compression, the resilient coupling between the pulley and the shaft permits relative rotation or slippage in the opposite (drag) direction so that the abrupt deceleration of the pulley is not transmitted immediately to the shaft. As described above for accelerations, the invention dampens and cushions rotational velocity changes due to abrupt deceleration of the pulley so that they are not imparted directly to the shaft. The drive system of the invention that affords this bidirectional smoothly varying coupling between a pulley and a rotating shaft to cushion and dampen the effects of differential rotational velocity changes will be described detail below. Similar abrupt differential rotational velocity variations also occur as varying electrical loads are imposed on the alternator that vary the force required to turn the alternator shaft.

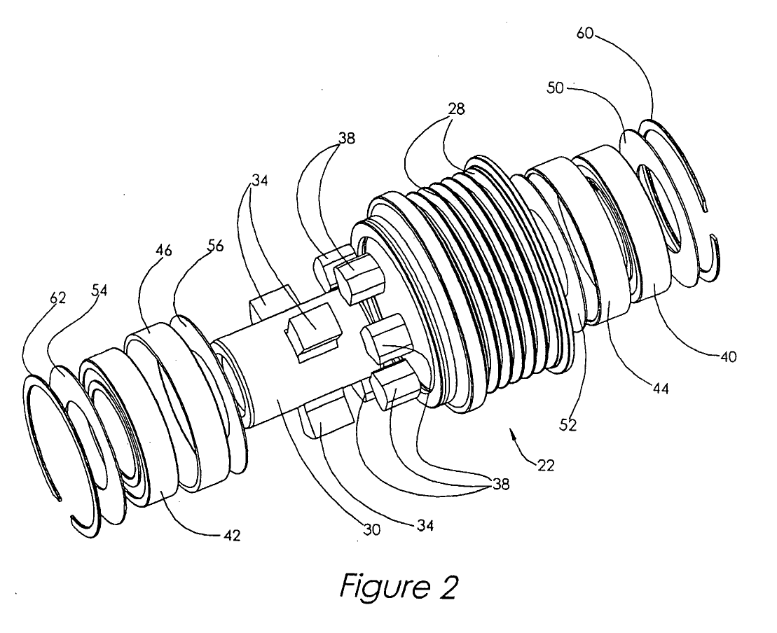

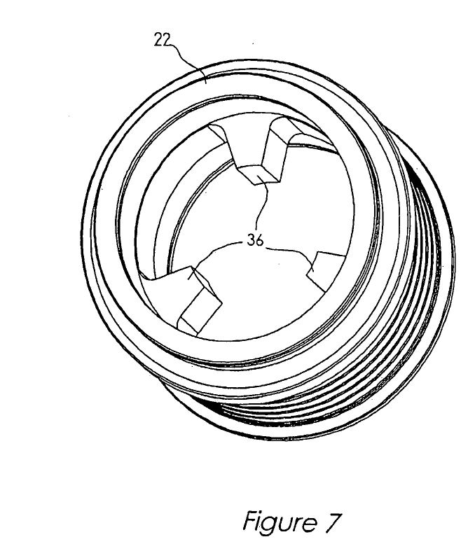

Referring to the figures, a pulley assembly 20 embodying the drive system 26 in accordance with a first embodiment the invention may comprise the pulley 22 and a hub 30. As shown in FIGS. 2 and 7, the pulley 22 may comprise a cylindrical tubular member or barrel (for a serpentine drive belt) having a plurality of circumferential ribs and grooves 28 formed about its exterior surface that are adapted to mate with corresponding ribs and grooves of a serpentine belt (not shown) to rotate the pulley. For other types of drives, e.g., poly V-belts, chains or gears, the pulley body may have other appropriate external configurations. The pulley barrel also has a plurality of radially inwardly extending projections 36 formed about its inner circumferential surface, the projections preferably having a generally truncated pyramidal cross sectional shape and a bar shape when viewed from their longitudinal side, and may extend axially a short distance along the along the inner circumferential surface of the pulley barrel, as shown in FIG. 7. In a preferred embodiment, there are three projections 36 symmetrically disposed about the inner diameter, and the projections are all similarly shaped.

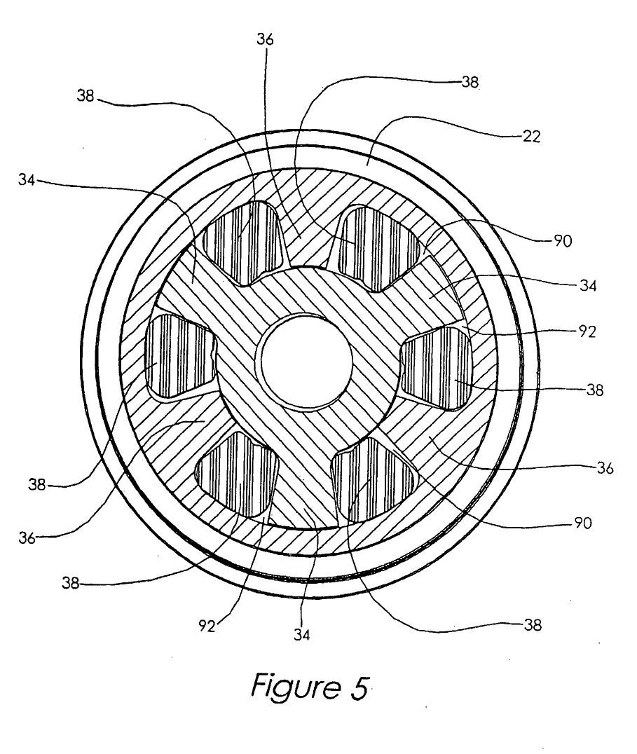

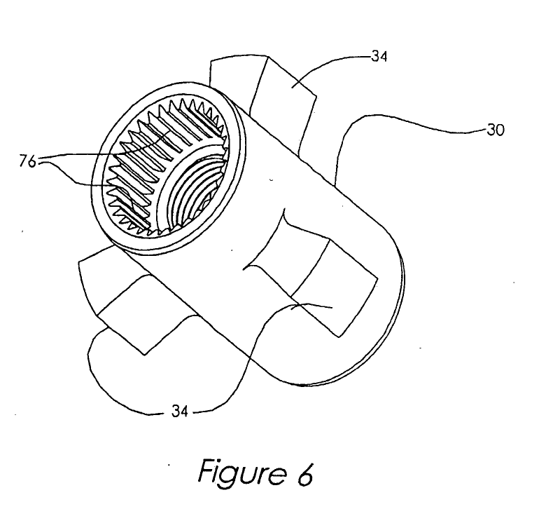

The hub 30 preferably has a generally cylindrical tubular shape, as shown in FIGS. 2 and 6, and is adapted to be connected to shaft 24 and to be journaled, i.e., supported as by bearings, concentrically within the interior cavity of the pulley 22 to rotatably support the pulley for limited rotation on the hub. The hub has a plurality of radially outwardly extending projections 34 formed on its exterior circumferential surface that cooperate with the corresponding plurality of radially inwardly extending projections 36 formed on the interior facing surface of the pulley, as best illustrated in FIG. 5. Projections 34 may also have a generally truncated pyramidal cross sectional shape and a bar shape when viewed from their longitudinal side, and may extend axially a short distance along the outer circumferential surface of the hub. As with projections 36 of the pulley, the projections 34 are symmetrically located about the outer circumference of the hub. When assembled with the pulley, projections 34 of the hub 30 are interleaved between the projections 36 of the pulley 22, and the projections are sized in a circumferential dimension such that spaces are formed between adjacent projections 34 and 36. The projections effectively comprise interleaved paddles spaced about the inner circumference of the pulley and the outer circumference of the hub. As shown in FIG. 5, a plurality of solid resilient polymer spring members 38 (to be described below) are disposed in the cavity spaces between the adjacent projections 34 and 36. The polymer spring members afford a springy connection between the pulley and the hub (and the shaft) and resilient relative angular bidirectional rotation of the pulley and shaft over a predetermined angular range, as will be described.

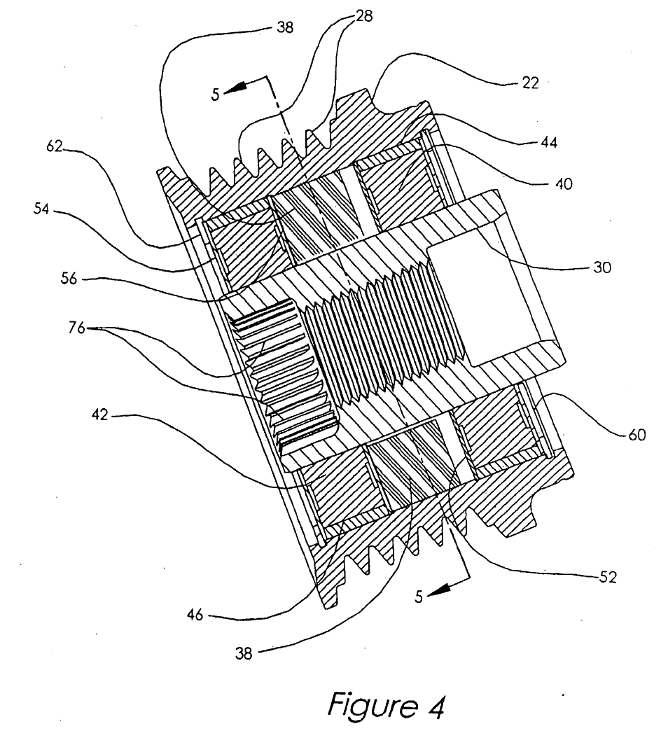

Hub 30 may be mounted on shaft 24, as will be described, and journaled concentrically within pulley 22 by a first bearing 40 at the rear or right end (in the figures) of the pulley assembly adjacent to the alternator housing (not shown) and by a second bearing 42 disposed at the forward or left end of the pulley assembly. As shown in FIGS. 2 and 4, each bearing 40, 42 may be disposed within a corresponding cylindrical tubular bearing sleeve 44, 46, respectively, each having an inner diameter sized to fit closely over the outer diameter of the bearing and having an outer diameter sized to fit closely within the interior diameter of the pulley, as shown in FIG. 4. Each bearing and bearing sleeve form a bearing assembly, and each bearing assembly may also include a pair of outer and inner annular shield washers 50, 52, and 54, 56, respectively, disposed on opposite sides of each bearing assembly. The two assemblies are disposed within the interior of the pulley 22 adjacent to its right and left ends (in the figures). A pair of retaining rings 60, 62, as of spring steel for example, may be snap fitted within corresponding circumferential grooves formed in the inside diameter of the pulley at each of its ends to properly locate the bearing assemblies and the hub within the pulley, and to journal the hub and pulley for the relative rotational movement. The retaining rings retain the components of the drive system appropriately located within the interior cavity of the pulley, and maintain the pulley and drive system connected. Bearings 40 and 42 may be the same or different types of bearings, and may comprise, for example, ball bearings, roller bearings, or bushings.

The forward (left) end of shaft 24 (not shown in the figures) on which the pulley assembly is mounted may be threaded, and the interior bore of the tubular hub 30 may have corresponding mating internal threads 72, as shown in FIG. 4, to connect the hub to the shaft. A shaft lock (not shown) comprising a disk having circumferential threads or points that mate with corresponding splines 76 within the forward interior end of hub shaft 30 (see FIG. 4) may be used in a well known manner to hold the hub 30 fixed in place on the shaft 24.

In the preferred embodiment illustrated in the figures, there are three cooperating projections 34, 36 formed on each of the exterior of the hub and the interior of the pulley, as noted above, and the projections are preferably spaced symmetrically at angles of 120° around the circumferences. Other embodiments may have more or fewer projections; the projections may be of different shapes and sizes; and they may be asymmetrically spaced. The pulley and the hub may be of any suitable material, such as steel, for example, although the pulley is preferably formed of a polymeric material such as a glass filled phenolic that is commercially available under the name Durez® and available from Sumitomo Bakelite Co. Ltd. of Novi, Mich. This phenolic material is advantageous for several reasons. It is lightweight, relatively inexpensive, and affords good performance and long life. Moreover, it is a thermal insulator that reduces heat conduction through the alternator shaft and pulley to the drive belt, which helps to reduces wear and prolong the life of the belt.

As noted above, the projections 34, 36 cooperate with the polymer spring members 38 to afford resilient bidirectional relative angular rotation between the pulley and the hub (and shaft). The materials from which the spring members are formed, as well as their shapes and sizes relative to the volumes of the cavities between the projections 34, 36 determine the characteristics of the resilient connection between the pulley and the hub.

The spring members are preferably formed of a resilient polymer material and are solid members, meaning that they are formed of bulk resilient polymer material with or without voids or holes, as will be described. Resilient polymer materials are preferably selected to have a wide temperature range, for example, −20° C. to 130° C., over which temperatures the physical properties of the material remain essentially unchanged. Additionally, the resilient properties of the materials are preferably characterized by a rapid response to force changes, and the properties remain substantially constant in the presence of exposure to repeated temperature cycles or load cycles. Preferred materials that have the above characteristics and which have been found to be particularly suitable for the springs comprise polymers such as polyether urethanes having a Shore A durometer hardness in the range of 60 to 90, polyester urethanes in the same hardness range, and co-polymers such as co-polyesters of fully polymerized hard segments of crystalline polybutylene-terephthalate (PBT) and soft segments of amorphous polyesters or polyethers. Suitable such co-polymers are commercially available under the name Arnitel® from DSM Engineering Plastics B.V. of The Netherlands (P.O. Box 43; 6130 AA Sittard; The Netherlands). For some applications, other materials that may be useful for the spring members include silicone rubbers.

In a preferred embodiment, as shown in FIGS. 2 and 5-7, the cooperating projections 34 and 36 and the inner shield washers 50 and 54 together form truncated pyramidal or pie-shaped cavities in which the spring members are located. The polymer spring members may have a variety of different shapes, sizes and configurations depending upon the desired spring characteristics. Preferably they have a prismatic solid shape, such as the truncated pyramidal shaped members as shown in FIGS. 2, 5 and 8A-B that match the shapes of the cavities between the projections. These shapes will lie within the truncated pyramidal (pie-shaped) cavities between the projections and deform during relative rotation of the hub and pulley in predictable ways.

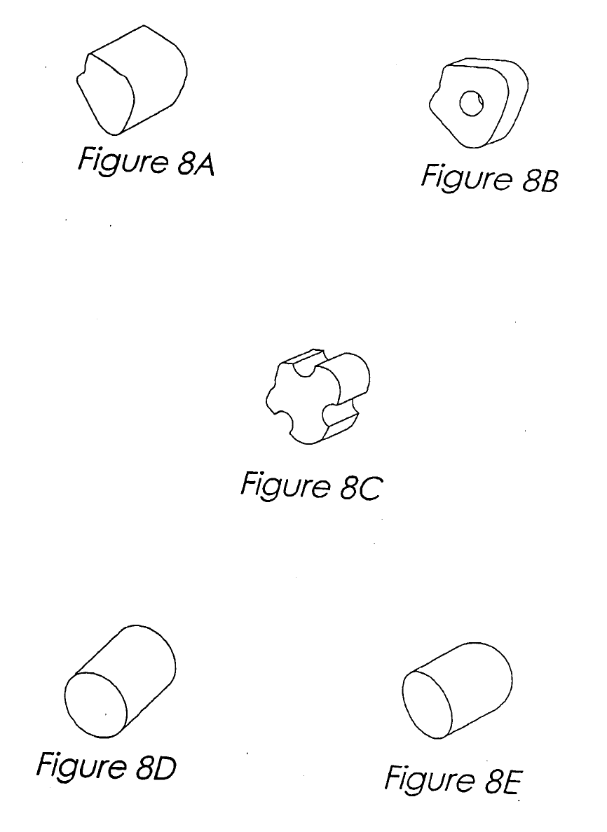

The effective spring rate can be varied by varying the shapes of the spring members. Other spring shapes, as well as spherical shapes, have also been found suitable and may be used. Shapes may vary in transverse and longitudinal cross section from the truncated pyramidal transverse cross sectional—axial rectangular cross section shaped spring members as shown in FIGS. 8A-B to other geometric shapes such as shown in FIGS. 8C-E. Each shape will have different gross spring properties, and the properties may be varied by including holes or voids, as shown for example in FIGS. 8B-C. Examples of spring member configurations which have been found useful include cylinders, such as shown in FIG. 8D, cylinders with a dome-shaped end, such as shown in FIG. 8E, cylinders with one or more holes through them, rectangular shaped members, rectangular shaped members with one or more holes, and other multi-faceted shapes with voids such as shown in FIG. 8C. As noted above, the term “solid spring member” as used herein refers to unitary spring members formed of bulk resilient spring material, and includes such members both with and without holes or voids.

The characteristics and the responsiveness of the springy connection between the pulley and the hub are also determined by the volumes of the spring members relative to the volumes of the cavities between the projections in which the spring members are located. The volume of a spring member is determined by its size and shape, and by whether the spring member has holes or voids in it. The volume of a cavity between opposing projections changes during operation due to the relative angular rotation of the pulley and the hub, as well as according to the direction of rotation. As can be appreciated from FIG. 5, upon relative angular rotation of the pulley and the hub, the volumes of the adjacent cavities 90 and 92 on opposite sides of a given hub projection 34 will correspondingly decrease and increase depending upon the direction of rotation of the pulley 22 relative to the hub 30. If the pulley rotates clockwise (in FIG. 5) relative to the hub, cavities 90 will decrease in volume as every other one of the pulley projections 36 moves toward a hub projection 34, while cavities 92 on the opposite sides of the hub projections will increase their volumes correspondingly as the hub and pulley projections move apart. Thus, the spring members in cavities 90 will be compressed, while those in cavities 92 will not be, and only the compressed spring members in cavities 90 will exert a resilient counter restoring force and contribute to the overall spring rate of the pulley assembly in the clockwise direction. When the pulley rotates in the opposite counterclockwise direction relative to the hub, alternating cavities 92 are reduced in volume while cavities 90 increase their volumes, and only the spring members in cavities 92 exert counter restoring forces.

Holes and voids are useful for adjusting the volume of a spring member without changing its overall external size or configuration to afford a predetermined maximum angle of relative rotation of the hub and pulley over which the spring member deforms before its volume equals the cavity volume and it locks further rotation. Preferably, the volume of the spring members is selected so that the volume of the cavities in the neutral position (no relative rotation) is of the order of 125% to 250% of the volume of the spring members.

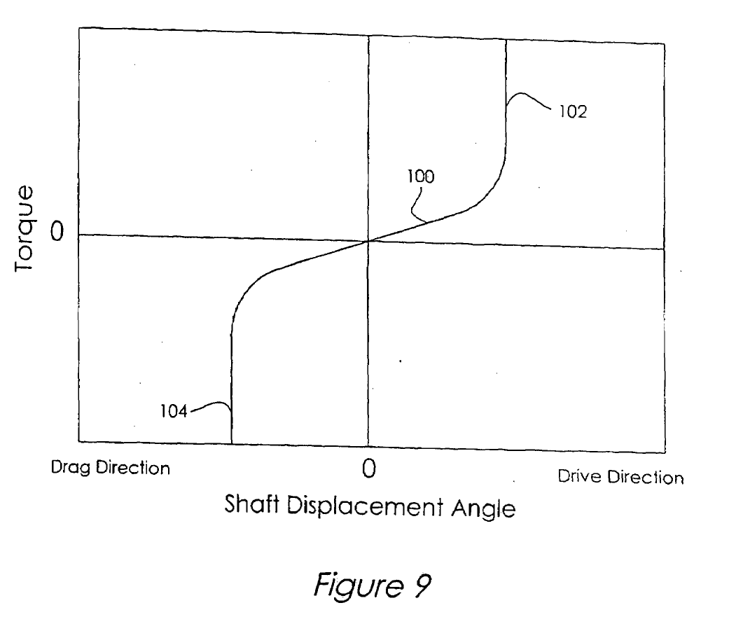

If a spring member has a cross section that just contacts, or is slightly oversized relative to, the opposing faces of the projections that form the spring cavity, the spring behavior starts immediately from the rest or neutral position. The curve of FIG. 9 which plots spring rate as a function of torque and shaft displacement angle illustrates this situation for the symmetrical embodiment illustrated in FIGS. 2 and 4-7. As the pulley and the hub rotate relative to one another, i.e., the relative angular displacement between the shaft and the pulley moves from the neutral position (zero shaft displacement angle and zero torque) in either the drive direction or in the drag direction, alternating spring members begin to resiliently deform and to exert a resilient increasing counterforce against opposing projections as their cavity volumes decrease, which results in an increase in torque. As shown in FIG. 9, torque changes substantially linearly with shaft angular displacement (as shown at 100) over a range of angular displacements about the neutral of zero position as the spring members are initially resiliently deformed and begin to fill the cavities. As the volumes of the spring members and the cavities closely approach one another, the characteristic changes non-linearly until the volume of a spring cavity equals the volume of the corresponding spring member, at which point the pulley and the shaft become angularly locked (as shown at 102, 104) for higher loads and essentially no further angular displacement occurs. As shown, the spring rate characteristic transitions smoothly from the linear condition 100 to the locked condition at 102 and 104.

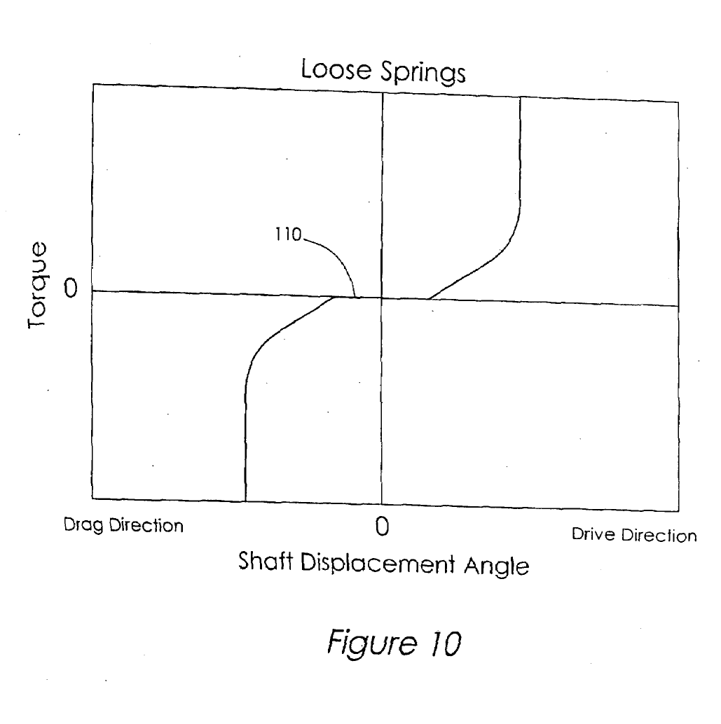

The spring rate characteristics shown in FIG. 9 illustrate the situation where the spring members are sized to be close-fitting within the cavities between the pulley and the hub projections, and have substantially the same shape as the cavities. In an alternative “loose springs” embodiment, as shown in FIG. 10, the spring members may have a cross-section that is somewhat undersized compared to the cavities formed by opposing faces of the projections, i.e., the spring members are “loose” within the cavities. In this case, there is no spring response for a limited range of relative angular rotation 110 about the neutral or zero position. In this region of shaft angular displacement, the spring members are not engaged by the opposing projections as their cavity volumes decrease, and there is no increase in torque. However, as the relative displacement of the shaft and the pulley increases and the opposing projections begin to reduce the spring member cavity volumes and contact the spring members, the spring rate increases in a way similar to that illustrated in FIG. 9 until a maximum shaft displacement angle is reached where the spring member volume equals the cavity volume and the pulley and shaft become angularly locked. As noted above, the volume of the spring members is preferably selected a desired predetermined range of angular rotation is afforded.

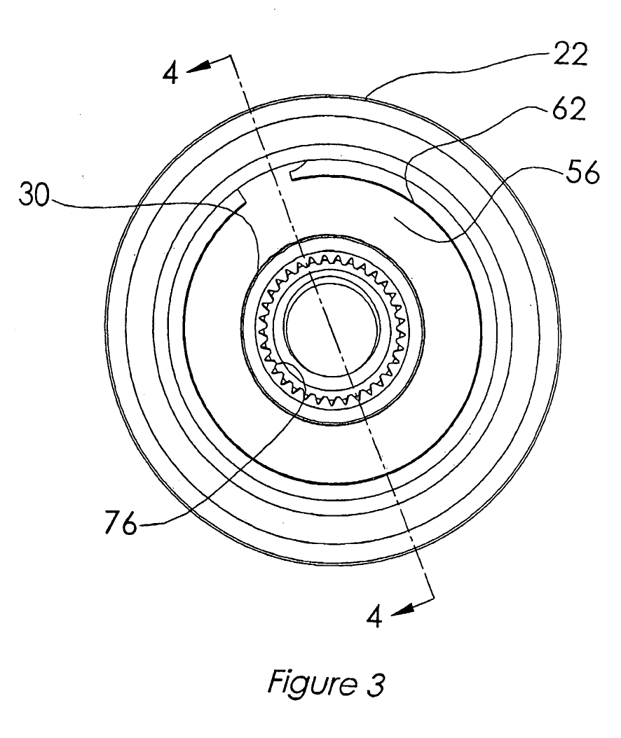

The spring rate characteristics shown in FIGS. 9 and 10 are for a symmetrical embodiment of the pulley assembly and drive system such as illustrated in FIGS. 2-8, where the spring members are the same in the adjacent cavities. As shown in FIGS. 9 and 10, the characteristics are symmetrical about the neutral position and are the same but of opposite polarity in opposite drive and drag rotational directions. Normally, it is preferable that spring rate characteristics be the same in opposite rotational directions, i.e., be symmetrical about the neutral position, although for some applications it may be desirable that the spring rates be asymmetrical and different in opposite rotational directions.

An asymmetrical spring arrangement may be implemented by making the cavities in the driving sections, i.e., the spaces that decrease in volume for a “drive” direction of angular rotation of the pulley assembly, different from those in the “drag” or retarding sections, i.e., the spaces that increase in volume for a “drag” direction of rotation. The driving and the retarding cavity spaces alternate in the circumferential direction about the pulley assembly, since when a driving cavity volume is decreasing, the volume of an adjacent retarding cavity is increasing, as previously described. Asymmetrical spring characteristics may be afforded, for example, by forming the spring members in the adjacent cavities to be different. For example, the spring members in the three driving cavities of the embodiment illustrated in FIG. 5 may have a larger cross-section and volume than the spring members in the three alternating retarding cavities or be of different materials. Thus, the drive system will have different characteristics and react differently for different directions of rotation.

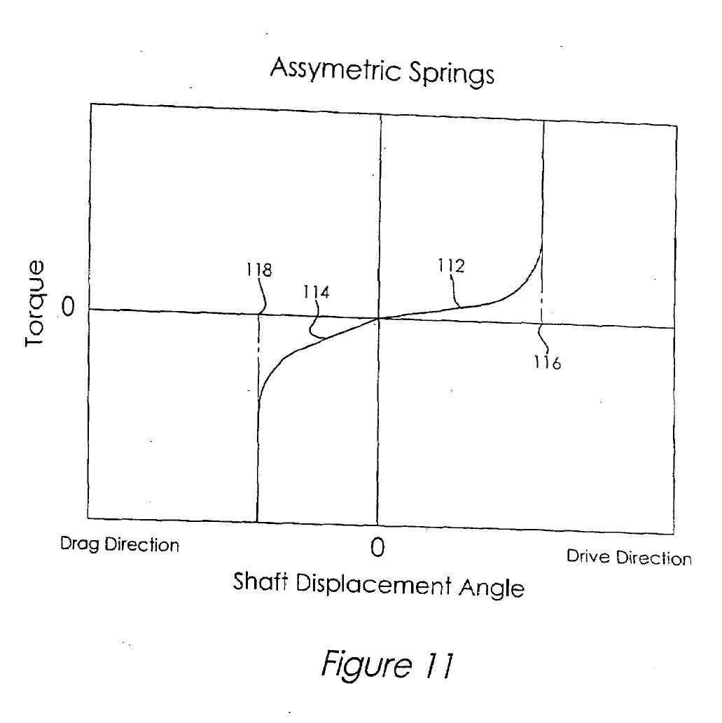

FIG. 11 is an example of the spring rate characteristic of an asymmetrical spring embodiment. As shown, the slopes 112 and 114 of the linear portions of the torque versus shaft displacement angle curve are different about the neutral shaft displacement position for the driving and drag directions, respectively. Moreover, the shaft displacement angles 116 and 118 for a lock condition in the different directions are different. As shown, in the driving direction, the slope 112 is less than the slope 114 in the drag or retarding position, and a greater shaft displacement angle 116 is required for a lock condition in the driving direction than the angle 118 in the drag direction.

In operation, the pulley and the hub remain positively engaged. There is always positive engagement between the pulley and the shaft through the spring members. Unlike designs with one-way clutches, the drive system of the invention does not have an overrunning condition where the pulley and shaft free run. When the rotational velocity of the pulley suddenly changes, as when the pulley experiences a sudden acceleration during combustion, the drive system of the invention permits instantaneous angular deviation or slippage between the pulley and the shaft while maintaining the pulley and shaft in positive engagement. As the pulley accelerates, the inertia and torsional load of the alternator shaft and armature tend to maintain the rotational speed of the shaft constant and prevent it from instantaneously following the pulley. The spring members in the driving sections resiliently deform to cushion the abrupt angular deviation between the pulley and the shaft and reduce noise and vibration, while exerting an increasing force (torque) on the shaft with angular rotational, causing the shaft to accelerate to match the rotational speed of the pulley. The spring rate of the spring members may be selected to cushion appropriately abrupt increases of pulley speed and abrupt decreases of pulley speed relative to the alternator shaft speed.

As the rotational speed of the alternator shaft increases and the speed differential between the pulley and the shaft decreases, the amount of force required to rotate the alternator shaft decreases. The resiliency of the spring members returns the shaft and the pulley to the neutral position where they will typically remain until the pulley experiences another rotational perturbation, typically in the opposite direction.

When the rotational speed of the pulley suddenly decelerates, as during compression, the springy connection between the hub and pulley allows relative rotation between the pulley and the shaft in the opposite direction, even to the extent that the spring cavity sections reverse function. The inertia of the alternator shaft and armature tends to maintain the rotational speed of the alternator shaft as the pulley abruptly slows. The springy connection during deceleration of the pulley operates in a similar manner to that described above for acceleration. The spring members in the alternating cavities that increased in volume during acceleration of the pulley are now in cavities whose volume is decreasing. If the relative rotation in the decelerating direction proceeds past the neutral, or unloaded, position, the spring members in the cavities where the volume is decreasing now resiliently deform. They cushion the abrupt rotational speed differential to reduce noise and vibration, and exert a retarding force or drag on the shaft causing its rotational speed to decrease. As the differential rotational velocity between the pulley and the shaft decreases, the torsional force presented by the shaft is reduced and the shaft and pulley return to the neutral position.

Since, as noted, the invention does not employ a one-way clutch, the drive system of the invention does not have an overrunning condition where the pulley and shaft free run. Thus, the invention may be used in belt-alternator-starter (“BAS”) applications, where one-way clutches cannot be used. In BAS systems, the alternator may be used as a starter for the engine by supplying electrical power to the alternator to turn its shaft. Since the pulley assembly locks up at a predetermined shaft displacement angle, the pulley can supply torque to turn the engine crankshaft through the drive belt. Once the engine starts, the power to the alternator can be disconnected, in a well known way, and the alternator may revert to its usual function. In this application, the alternator becomes the prime mover driver for the rotary crankshaft of the engine during starting.

As may be appreciated from the foregoing, the drive system of the invention provides a simple and elegant solution to the problem of compensating for both sudden acceleration as well as sudden deceleration of a pulley connected to the shaft of a rotating device. Not only does the invention operate equally bidirectionally to compensate for and dampen abrupt accelerations and decelerations, it operates substantially instantaneously and maintains positive contact between the pulley and the shaft, permitting greater control over the compensation. Accordingly, the invention is very effective in substantially reducing or eliminating vibration and noise in rotating devices, such as automotive alternators, caused by the pulsating characteristics of a prime mover driver such as an internal combustion engine.

Although the invention has been described in the context of, and is particularly applicable to, an automotive application where rotating devices are driven by a serpentine belt and an internal combustion engine, it will be appreciated that the invention has other applications. Indeed, the invention may be used effectively to dampen sudden rotational velocity changes in many different types of systems driven by many different types of prime movers. The invention may be used in any application where a high mass device, like an alternator rotor, is being driven by a fluctuating power source, to attenuate the pulsating effect of varying electrical loads. The invention is particularly useful to compensate for fluctuations where the frequency of fluctuations is in the range of one to six fluctuations per revolution.

As mentioned above, the invention may also be used with other types of drive connections, such as conventional poly-V belts, composite rubber V-belts, spur gears or helical gears. For such applications, a pulley, hub and spring members will still be used. However, the pulley will not have a tubular exterior configuration, but rather it will be tailored to particular drive connection. In the case of a V-belt, the pulley may have a standard outer diameter and conventional V-shaped belt groove, but may have, for example, a stepped configuration, as viewed axially, with the cooperating projections and spring members disposed axially forward of the V-shaped groove. This is particularly advantageous with front wheel drive vehicles, for instance, where space may be limited.

While the foregoing has been with reference to particular described embodiments of the invention, it will be appreciated by those skilled in the art that changes to these embodiments may be made without departing from the principles of the invention, the scope of which is defined by the appended claims.

1. A drive system for a rotary device having a shaft, comprising:
a pulley adapted to be rotated by a prime mover, the pulley having a first plurality of radial projections extending from an inner surface of the pulley;
a hub connected to the shaft and journaled within the pulley, the hub having a second plurality of radial projections extending from an outer surface of the hub, the first and second pluralities of projections being interleaved and forming a plurality of spaces therebetween;
a pair of annular members located on the hub axially on opposite sides of said projections that together with said projections and said spaces define a plurality of cavities; and
a plurality of solid resilient polymer spring members disposed in said cavities, said resilient polymer of said spring members being selected from the group consisting of polyether urethanes, polyester urethanes, and co-polyesters of fully polymerized hard segments of crystalline polybutylene-terephthalate (PBT) and soft segments of amorphous polyesters or polyethers, the spring members having a size relative to the cavities such that the spring members engage the first and second projections and, upon sudden relative angular bidirectional velocity changes between the prime mover and shaft and corresponding relative angular rotation of the pulley and the hub, the projections resiliently deform said spring members within said cavities to dampen the impact of said velocity changes on the shaft until a predetermined maximum relative angular rotation is reached.

2. The drive system of claim 1, wherein the resilient polymer is selected such that the spring members exert an increasing counter force against the projections with relative angular rotation of the pulley and hub to produce an increasing torque on the shaft that acts to reduce said relative angular velocity and rotational deviations.

3. (canceled)

4. The drive system of claim 1, wherein said resilient polymer comprises materials that are characterized by a rapid response to force changes, and have properties that remain substantially constant in the presence of repeated temperature cycles and load cycles.

5. The drive system of claim 1, wherein said spring members are sized such that the cavities have a volume prior to said relative rotation that is in the range of about 125% to 250% of the volume of the spring members.

6. The drive system of claim 5, wherein said spring members resiliently deform within the cavities upon said relative angular rotation until the volume of the cavities and the volume of the spring members are equal, said resilient deformation and said relative rotation ceasing upon said volumes becoming equal.

7. The drive system of claim 5, wherein the spring members are formed with holes or voids to adjust the volume of the spring members to afford said predetermined maximum relative angular rotation.

8. The drive system of claim 7, wherein the spring members are sized to afford a preselected range of bidirectional angular deviations about a neutral position where the spring members are not resiliently deformed, and are formed to afford a predetermined spring rate characteristic at angular deviations greater than said preselected range.

9. The drive system of claim 1, wherein the spring members in alternating cavities are formed differently to afford asymmetrical spring rate characteristics for different directions of rotation.

10. The drive system of claim 1, wherein said spring members are formed to have a cross section and a shape in an axial direction that correspond, respectively, to the cross section and shape of the cavities.

11. The drive system of claim 1, wherein the first and second projections are, respectively, symmetrically disposed at equal angles around an inner circumference of the pulley and an outer circumference of the hub.

12. The drive system of claim 8, wherein prime mover is an internal combustion engine, the rotary device is an alternator, and pulley is connected to the engine by a drive belt, and wherein the spring rate is selected to exert a counter force sufficient to overcome torque loads presented by the shaft upon bidirectional rotational velocity changes of the engine.

13. The drive system of claim 12, wherein the drive belt is one of a serpentine belt and a poly-V belt.

14. The drive system of claim 12, wherein said pulley is formed of a thermally insulating polymeric material to reduce heat transfer to the drive belt through the shaft of the alternator.

15. The drive system of claim 14, wherein said thermally insulating polymeric material is glass filled phenolic.

16. (canceled)

17. (canceled)

18. A drive system for a rotary device having a shaft, comprising:
a pulley adapted to be connected to a drive belt, the pulley having a first plurality of radial projections extending from an inner surface of the pulley;
a hub connected to the shaft and journaled within the pulley, the hub having a second plurality of radial projections extending from an outer surface of the hub, the first and second pluralities of projections being interleaved and forming a plurality of cavities therebetween;
a plurality of solid spring members formed of a resilient polymer disposed in said cavities, the resilient polymer being selected from the group consisting of polyether urethanes, polyester urethanes, and co-polyesters of fully polymerized hard segments of crystalline polybutylene-terephthalate (PBT) and soft segments of amorphous polyesters or polyethers, wherein upon sudden relative angular bidirectional rotational deviations between the pulley and the hub, the projections resiliently deform said spring members within said cavities to dampen the impact of said rotational deviations on the shaft.

19. The drive system of claim 18, wherein the spring members are formed to have a spring member volume such that a cavity volume of the cavities is of the order of about 125% to 250% of the spring member volume.

20. The drive system of claim 18, wherein the spring members resiliently deform within the cavities upon said relative angular rotation until the volume of the cavities and volume of the spring members are equal, said resilient deformation and said relative rotation ceasing upon said volumes becoming equal.

21. The drive system of claim 18, wherein said spring members afford instantaneous relative rotation of the pulley and the hub upon the pulley experiencing sudden acceleration or deceleration, and the spring members upon being deformed exert restoring forces that increase with increasing relative angular deviation between the pulley and hub to reduce said relative angular rotation.

22. The drive system of claim 18, wherein the spring members are selected to have configurations selected from the group consisting of prismatic shaped members, cylinders, cylinders with a dome-shaped end, rectangular shaped members, and multi-faceted shapes, all with and without holes and voids.

23. The drive system of claim 18, wherein the drive belt is one of a serpentine belt and a poly-V belt and is connected to an internal combustion engine, and the rotary device is an alternator, and wherein the spring members are formed to have a spring rate selected to exert a counter force sufficient to overcome torque loads presented by the shaft upon bidirectional rotational velocity changes of the engine.

24. The drive system of claim 23, wherein the alternator is adapted to receive power and to function as a starter for the engine, and the spring members are formed to lock the drive system to allow the alternator to turn over the engine until it starts.
